(19) United States
(12) Patent Application Publication
(10) Pub. No.: US 2006/0168113 A1
(43) Pub. Date: Jul. 27, 2006

(54) File transfer management systems and methods

(75) Inventors: Ken-Ju Jung, Hsinchu City (TW); Mao-I Wu, Hsinchu City (TW); G. Y. Chen, Taoyuan City (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: Taiwan Semiconductor Manufacturing Co., Ltd.

(21) Appl. No.: 11/042,626

(22) Filed: Jan. 25, 2005

(51) Int. Cl. G06F 15/16

(52) U.S. Cl. 709/218

(57) ABSTRACT

Systems and methods for file transfer management. A portal server receives a file transfer request from a client computer and performs file transfers between the client computer and a file server via leased line. The client computer connects to the portal server via Internet. The portal server connects to the file server via leased line.

### BACKGROUND

The invention relates to data management, and more particularly, to systems and methods of file transfer management.

A network allows users to share resources on their own systems with other network users and to access information on centrally located systems or systems that are located at remote offices. Internet and IP networks, in general, were designed to provide large-scale interconnection of computers and networks. Internet provides rapid access for millions of client machines to hundreds of thousands of servers (mostly providing HTTP, FTP and email services). Large size data transfers over Internet, however, requires excessive time and are generally not secure.

### SUMMARY

Systems for file transfer management are provided. An exemplary system provides a portal server receiving a file transfer request from a client computer and performing file transfers between a client computer and a file server via leased line. The client computer connects to the portal server via Internet. The portal server connects to the file server via leased line. The portal server may further acquire a first transmission measurement representing the required time from the portal server to the file server and back via Internet. A second transmission measurement representing the required time from the portal server to the file server and back via leased line is acquired to determine whether the second transmission measurement exceeds to the first transmission measurement. If the second transmission measurement exceeds the first transmission measurement, file transfers between the client computer and the file server are performed via leased line. The portal server may further perform file transfers between the client computer and the file server via Internet or issue a message suggesting that the client computer performs the file transfer via Internet if the second transmission measurement is lower than the first transmission measurement.

An exemplary system may further comprise a proxy server connecting to the portal server via a firewall, and connecting to the file server via leased line. The portal server may issue the file transfer request with a file identity to the proxy server. The proxy server may intercept the file transfer request to determine whether a cache file corresponding to the file identity is present, and, if the cache file is present, responds the cache file to the portal server, and otherwise, forwards the file transfer request to the file server to acquire a particular file corresponding to the file identity.

File transfer management methods are further provided. An exemplary method receives a file transfer request from a client computer and performs file transfers between the client computer and a file server via leased line. An exemplary method may further acquire a first transmission measurement representing required time from the portal server to the file server and back via Internet, acquire a second transmission measurement representing required time from the portal server to the file server and back via leased line, determine whether the second transmission measurement exceeds the first transmission measurement, and if the second transmission measurement exceeds the first transmission measurement, perform file transfers between the client computer and the file server via leased line. An exemplary method may further perform file transfers between the client computer and the file server via Internet or issue a message suggesting that the client computer performs the file transfer via Internet if the second transmission measurement is lower than the first transmission measurement.

A machine-readable storage medium storing a computer program which, when executed, performs the exemplary method of file transfer management is also provided.

Preferably, the first and second measurements are Round-Trip-Times (RTTs). The file transfer may utilize File Transfer Protocol (FTP), Simple Mail Transfer Protocol (SMTP) or Simple Object Access Protocol (SOAP).

### BRIEF DESCRIPTION OF THE DRAWINGS

File transfer management systems and methods will become apparent by referring to the following detailed description of embodiments with reference to the accompanying drawings, wherein:

FIG. 1 is a diagram of the network architecture of an embodiment of a data transfer management system;

FIG. 2 is a diagram of a hardware environment applicable to a computer and servers in an embodiment of a file transfer management system;

FIG. 3 is a flowchart showing an embodiment of a method of file transfer management;

FIG. 4 is a diagram of a storage medium storing a computer program providing an embodiment of a method of file transfer management.

### DESCRIPTION

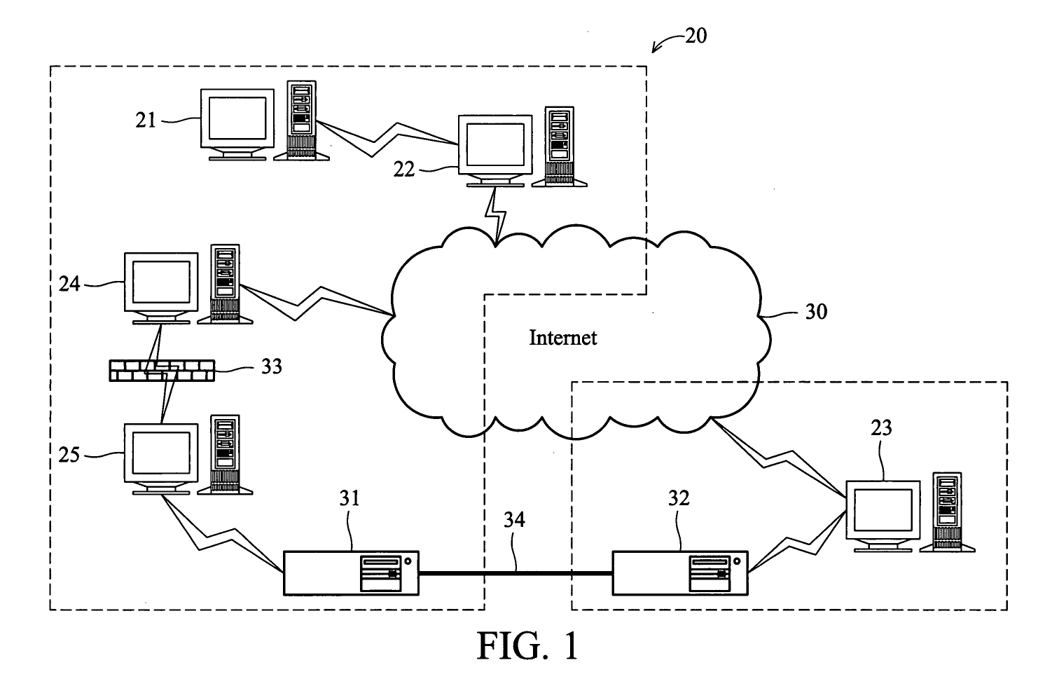

FIG. 1 is a diagram of the network architecture of an embodiment of a data transfer management system 20, comprising a client computer 21, an Internet Service Provider (ISP) server 22, a portal server 24, a proxy server 25, a firewall 33, a file server 23, and routers 31 and 32. The client computer 21, ISP server 22, portal server 24, proxy server 25, firewall 33 and router 31 reside in Japan, and the router 32 and file server 23 reside in Taiwan. The ISP server 22 provides access to the Internet while the client computer 21 is equipped with a Modem or an ADSL Modem with relevant software. The client computer 21 may transmit and receive large-size files, often over 1 GB, to and from the file server 23 via the ISP server 22 and Internet 30, however, this requires excessive time for data transfer due to Internet bandwidth and complicated network routing procedures.

The client computer 21 may access to the portal server 24 via Virtual Private Network (VPN) tunnels constructed by using public wires to connect the portal server 24. These tunnels use encryption and other security mechanisms to ensure that only authorized users can access the network and that the data cannot be intercepted. The firewall 33 is designed to prevent unauthorized access to or from a private network, and can be implemented in both hardware and software, or a combination of both. It is frequently used to prevent unauthorized Internet users from accessing private networks connected to Internet, particularly intranets. All messages entering or leaving the intranet pass via the firewall, which examines each message and blocks those that do not meet the specified security criteria. The portal server 24 provides access to the file server 23 selectively via Internet 30 or leased line 34 according to relevant transmission measurements, particularly Round-Trip-Times (RTTs), for Internet 30 and leased line 34. The proxy server 25 connects to the router 31 to perform message/file transfers between the portal server 24 and the file server 23. The proxy server 25 intercepts all requests to the file server 23 to determine whether a cache file corresponding to a requested file identity is present, and if so, responds with the requested cache file. If not, the request with the requested file identity is forwarded to the file server 23 to acquire a corresponding file. The proxy server 25 can dramatically improve file transfer performance as it saves the results of all requests for a certain amount of time. The router 31 connects to the router 32 in a peer-to-peer manner via leased line 34. Leased line 34 is a permanent telephone connection between the routers 31 and 32 provided by a common telecommunications carrier. Leased lines 34 are always active and used by businesses to connect geographically distant offices. Because the connection only carries client communications, the carrier can assure a given level of quality. Excessive bandwidth, such as 56 Mbps, is provided by leased line 34, thereby the client computer 21 can receive and transmit large-size files from and to the file server 23 much faster than via Internet 30.

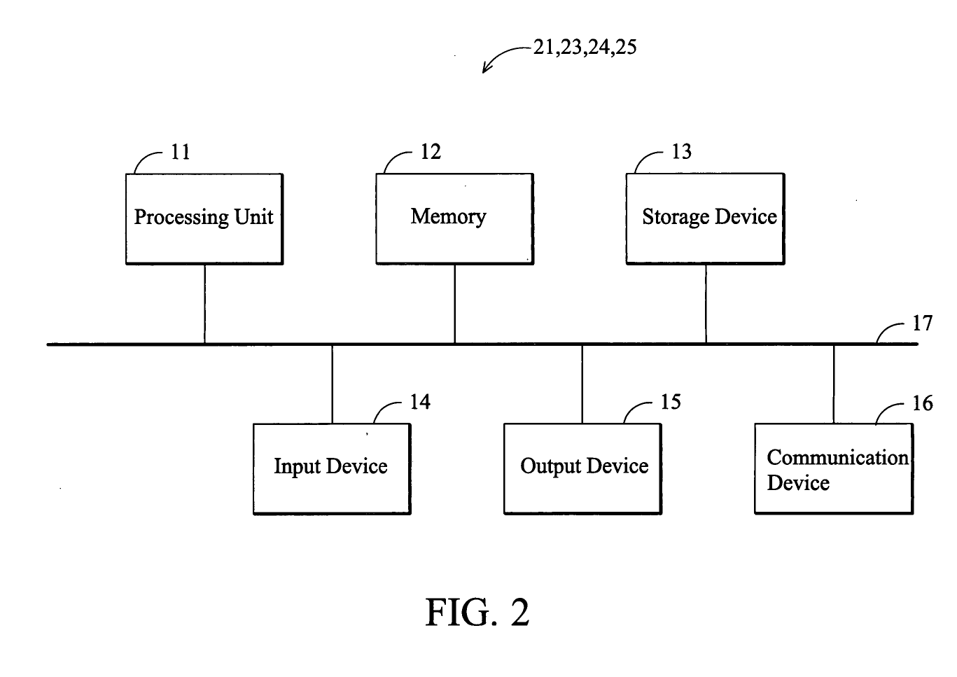

FIG. 2 is a diagram of a hardware environment applicable to computers 21, 23, 24 and 25 in an embodiment of a file transfer management system. The hardware environment of FIG. 2 includes a processing unit 11, a memory 12, a storage device 13, an input device 14, an output device 15 and a communication device 16. The processing unit 11 is connected by buses 17 to the memory 12, storage device 13, input device 14, output device 15 and communication device 16 based on Von Neumann architecture. There may be one or more processing units 11, such that the processor of the computer comprises a single central processing unit (CPU), a micro processing unit (MPU) or multiple processing units, commonly referred to as a parallel processing environment. The memory 12 is preferably a random access memory (RAM), but may also include read-only memory (ROM) or flash ROM. The memory 12 preferably stores program modules executed by the processing unit 11 to perform data transfer management functions. Generally, program modules include routines, programs, objects, components, scripts, Web pages, or others, that perform particular tasks or implement particular abstract data types. Moreover, those skilled in the art will understand that some embodiments may be practiced with other computer system configurations, including hand-held devices, multiprocessor-based, microprocessor-based or programmable consumer electronics, network PCs, minicomputers, mainframe computers, and the like. Some embodiments may also be practiced in distributed computing environments where tasks are performed by remote processing devices linked via a communication network. In a distributed computing environment, program modules may be located in both local and remote memory storage devices based on various remote access architecture such as DCOM, CORBA, Web objects, Web Services or other similar architectures. The storage device 13 may be a hard drive, magnetic drive, optical drive, portable drive, or nonvolatile memory drive. The drives and associated computer-readable media thereof (if required) provide nonvolatile storage of computer-readable instructions, data structures and program modules. The processing unit 11, controlled by program modules received from the memory 12 and from an operator via the input device, directs data transfer management functions.

The portal server 24 may comprise a Web server executed by the processing unit 11 therein. The Web server comprises several Web pages responsive to hypertext transfer protocol (HTTP) requests. Generally, information provided by the Web server is in the form of Web pages, generally in HTML (HyperText mark-up language) format, which is a text-based format that describes how the respective Web page is to be displayed by a computer, and provides textual information, typically in ASCII form, and graphical information generally in a compressed format such as “GIF” or “JPEG.” Such HTML documents may include scripts (e.g., JavaScript, Visual Basic Scripts, Active Server Page Scripts and the like) providing data transfer management functionality. The portal server 24 provides a single interface to receive a file transfer request from the client computer 21 and accordingly transfer file between the client computer 21 and the file server 23 via Internet 30 and leased line 34.

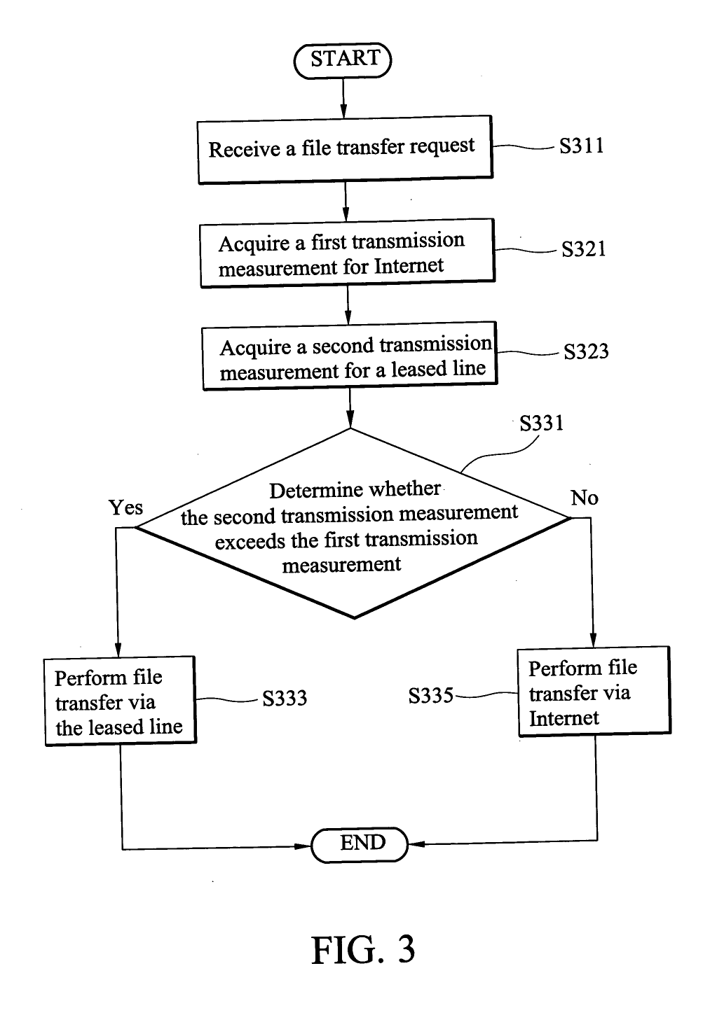

An embodiment of a file transfer management method employed by the portal server 24 is described in the following. FIG. 3 is a flowchart showing an embodiment of a method of file transfer management. In step S311, a file transfer request is received. The file transfer request may indicate receipt of a particular file from the file server 23, and alternatively, the file transfer request may further comprise a file and indicate transmission of the file to the file server 24. In step S321, a first transmission measurement, preferably RTT, is acquired, representing time required to travel from the portal server 24 to the file server 23 and back via Internet 30. In step S323, a second transmission measurement, preferably RTT, is acquired, representing time required to travel from the portal server 24 to the file server 23 and back via leased line 34. These transmission measurements may be periodically detected by the portal server 24, or be detected in real-time. In step S331, it is determined whether the second transmission measurement exceeds the first transmission measurement, and, if so, the process proceeds to the step S333, and otherwise, to the step S335. In step S333, the file transfer is performed via leased line 34. Specifically, it may further issue the file transfer request with a requested file identity to the proxy server 25. The proxy server 25 intercepts the file transfer request to determine whether a cache file corresponding to the requested file identity is present, and if so, responds with the requested cache file. If not, the request is forwarded to the file server 23. In step S335, the file transfer is performed via Internet 30. Alternatively, a message may be issued to the client computer 21 indicating that files will be received and transmitted from and to the file server 23 via Internet 30. Note that the file transfer may utilize a relevant communication protocol, such as File Transfer Protocol (FTP), Simple Mail Transfer Protocol (SMTP), Simple Object Access Protocol (SOAP) and the like.

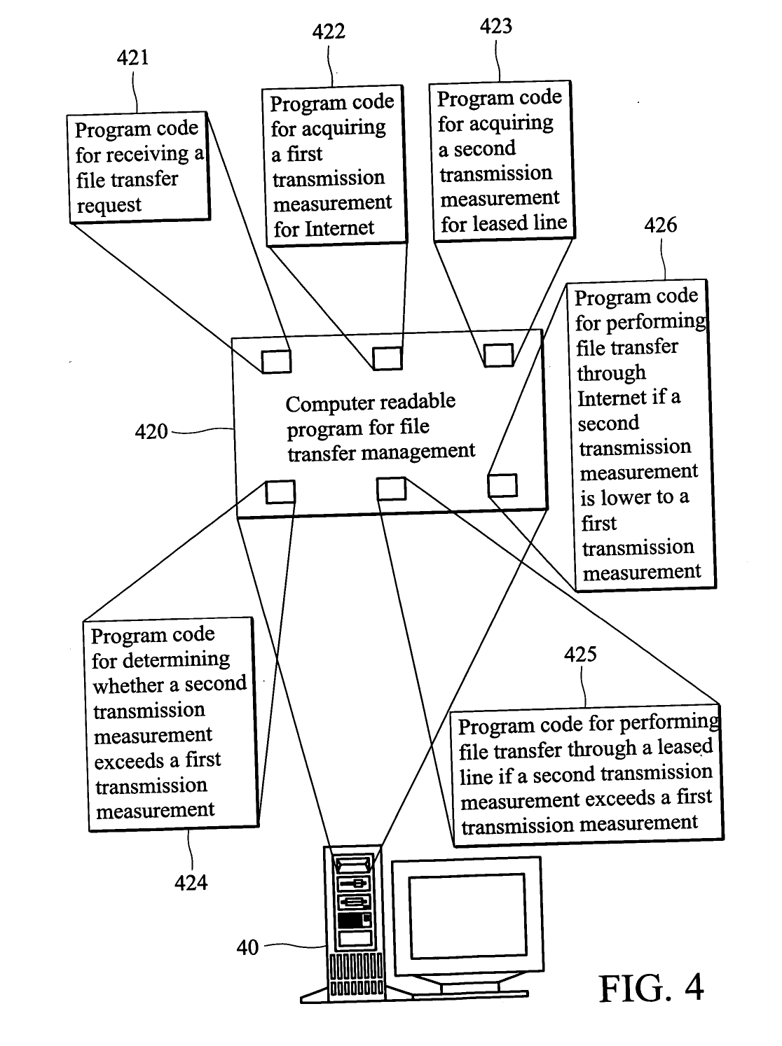

Also disclosed is a storage medium as shown in FIG. 4 storing a computer program 420 providing the disclosed method of file transfer management. The computer program product includes a storage medium 40 having computer readable program code embodied therein for use in a computer system. The computer readable program code comprises at least computer readable program code 421 receiving a file transfer request, computer readable program code 422 acquiring a first transmission measurement for Internet, computer readable program code 423 acquiring a second transmission measurement for leased line, computer readable program code 424 determining whether a second transmission measurement exceeds a first transmission measurement, computer readable program code 425 transferring files via leased line if a second transmission measurement exceeds a first transmission measurement, and computer readable program code 426 transferring files via Internet if a second transmission measurement is lower than a first transmission measurement.

File transfer management systems and methods, or certain aspects or portions thereof, may take the form of program code (i.e., instructions) embodied in tangible media, such as floppy diskettes, CD-ROMS, hard drives, or any other machine-readable storage medium, wherein, when the program code is loaded into and executed by a machine, such as a computer, the machine becomes an apparatus for practicing the invention. The disclosed methods and systems may also be embodied in the form of program code transmitted over some transmission medium, such as electrical wiring or cabling, through fiber optics, or via any other form of transmission, wherein, when the program code is received and loaded into and executed by a machine, such as a computer, the machine becomes an apparatus for practicing the invention. When implemented on a general-purpose processor, the program code combines with the processor to provide a unique apparatus that operates analogously to specific logic circuits.

Although the invention has been described in terms of preferred embodiment, it is not intended to limit the invention thereto. Those skilled in this technology can make various alterations and modifications without departing from the scope and spirit of the invention. Therefore, the scope of the invention shall be defined and protected by the following claims and their equivalents.

What is claimed is:

1. A system for file transfer management, comprising:
a portal server receiving a file transfer request from a client computer and performing file transfers between the client computer and a file server via leased line, wherein the client computer connects to the portal server via Internet, and the portal server connects to the file server via leased line.

2. The system of claim 1 wherein the portal server further acquires a first transmission measurement representing required time from the portal server to the file server and back via Internet, acquires a second transmission measurement representing required time from the portal server to the file server and back via leased line, determines whether the second transmission measurement exceeds the first transmission measurement, and if the second transmission measurement exceeds the first transmission measurement, performs file transfers between the client computer and the file server via leased line.

3. The system of claim 2 wherein the portal server further performs file transfers between the client computer and the file server via Internet if the second transmission measurement is lower than the first transmission measurement.

4. The system of claim 2 wherein the portal server further issues a message suggesting the client computer to perform file transfers via Internet if the second transmission measurement is lowers than the first transmission measurement.

5. The system of claim 2 wherein the first and second measurements are Round-Trip-Times (RTTs).

6. The system of claim 1 wherein the file transfer utilizes File Transfer Protocol (FTP), Simple Mail Transfer Protocol (SMTP) or Simple Object Access Protocol (SOAP).

7. The system of claim 6 further comprising a proxy server connecting to the portal server via a firewall, and connecting to the file server via leased line.

8. The system of claim 7 wherein the portal server issues the file transfer request with a file identity to the proxy server, the proxy server intercepts the file transfer request to determine whether a cache file corresponding to the file identity is present, and, if the cache file is present, responds to the portal server with the cache file, and otherwise, forwards the file transfer request to the file server to acquire a particular file corresponding to the file identity.

9. The system of claim 1 wherein the client computer connects to the portal server via a Virtual Private Network (VPN) tunnel.

10. The system of claim 1 wherein the portal server comprises a Web server receiving the file transfer request from the client computer.

11. A method of file transfer management performed by a portal server, comprising using a computer to perform the steps of:
receiving a file transfer request from a client computer; and
performing file transfers between the client computer and a file server via leased line,
wherein the client computer connects to the portal server via Internet, and the portal server connects to the file server via leased line.

12. The method of claim 11 further comprising the steps of:
acquiring a first transmission measurement representing required time from the portal server to the file server and back via Internet;
acquiring a second transmission measurement representing required time from the portal server to the file server and back via leased line;
determining whether the second transmission measurement exceeds the first transmission measurement; and
if the second transmission measurement exceeds the first transmission measurement, performing file transfers between the client computer and the file server via leased line.

13. The method of claim 12 further comprising a step of performing file transfers between the client computer and the file server via Internet if the second transmission measurement lowers to the first transmission measurement.

14. The method of claim 12 further comprising a step of issuing a message suggesting the client computer perform file transfers via Internet if the second transmission measurement is lower than the first transmission measurement.

15. The method of claim 12 wherein the first and second measurements are Round-Trip-Times (RTTs).

16. The method of claim 11 wherein the file transfer utilizes File Transfer Protocol (FTP), Simple Mail Transfer Protocol (SMTP) or Simple Object Access Protocol (SOAP).

17. The method of claim 11 wherein the file transfer request is received via a Web server.

18. A machine-readable storage medium storing a computer program which, when executed, performs a method for file transfer management comprising:
receiving a file transfer request from a client computer; and
performing file transfers between the client computer and a file server via leased line,
wherein the client computer connects to the portal server via Internet, and the portal server connects to the file server via leased line.

19. The machine-readable storage medium of claim 18 wherein the method further comprises the steps of:
acquiring a first transmission measurement representing required time from the portal server to the file server and back via Internet;
acquiring a second transmission measurement representing required time from the portal server to the file server and back via leased line;
determining whether the second transmission measurement exceeds the first transmission measurement; and
if the second transmission measurement exceeds the first transmission measurement, performing file transfers between the client computer and the file server via leased line.

20. The machine-readable storage medium of claim 19 wherein the method further comprises a step of performing file transfers between the client computer and the file server via Internet if the second transmission measurement is lower than the first transmission measurement.
